(19) United States
(12) Patent Application Publication
(10) Pub. No.: US 2026/0023369 A1
(43) Pub. Date: Jan. 22, 2026

(54) A METHOD OF CONTROLLING A RELIEF PLATE PRODUCTION SYSTEM COMPRISING A PLURALITY OF PRODUCTION UNITS, AND ASSOCIATED RELIEF PLATE PRODUCTION SYSTEM

(71) Applicant: XSYS Prepress NV, Ieper (BE)

(72) Inventor: Johan VERVAECKE, Kortrijk (BE)

(73) Assignee: XSYS Prepress NV, Ieper (BE)

(21) Appl. No.: 19/100,635

(22) PCT Filed: Aug. 2, 2023
(86) PCT No.: PCT/EP2023/071375

§ 371 Date: Feb. 3, 2025

(30) Foreign Application Priority Data
Aug. 4, 2022 (NL) 2032688
Feb. 16, 2023 (NL) 2034160

(51) Int. Cl. G05B 19/418

(52) U.S. Cl. CPC G05B 19/41865; G05B 2219/32283; G05B 2219/35414

(57) ABSTRACT

A method of controlling a relief plate production system comprising a plurality of production units, the method comprising the steps of: each of the plurality of production units receiving a job instruction from a central control means and storing said job instruction in a list of job instructions, said job instruction including at least an identifier of a relief plate to be produced from a relief precursor; after the plurality of production units have received the job instruction, one production unit of the plurality of production units receiving a relief precursor and an indication of the identifier of this relief precursor and treating the relief precursor in accordance with the received job instruction.

### FIELD OF THE INVENTION

The field of the invention relates to a relief plate production system. Various embodiments in this document relate to methods of controlling a relief plate production system, and an associated relief plate production system, production units, and a central control means.

### DESCRIPTION OF RELATED ART

In known methods of controlling a relief plate production system, to manufacture a certain relief printing plate specific commands need to be input in different production units in the production system. Typically, an operator brings a precursor to a production unit and enters for example the precursor type, and optionally selects other settings also.

The process can be made more autonomous using a central control means in communication with one or more production units. The central control means typically sends a job instruction to a first production unit of the production line, whereupon the job is performed by the first production unit. The central control means may further coordinate the operations of the production unit. The production units passively receive control signals from the central control means and carry out the steps as indicated in the control signals from the central control means.

In addition, in some known methods of controlling a relief plate production system all the controls which are sent to all the production units come from the central control means. The system is therefore heavily reliant on the proper functioning of the central control means. Also, once the production units are chosen by the central control means they are used for the plate production. There are few possibilities to switch the production units once the instruction is given by the central control means.

Furthermore, in some known methods of controlling a relief plate production system an additional production unit needs to be added to it. However, this additional production unit may not be manufactured by the same company as that of the production units already in the system. Any additional production unit may therefore not be compatible with the units already in the system, and the additional production unit may not be able to receive or understand any control signals normally received by the existing production units.

### SUMMARY OF THE INVENTION

Some embodiments of the present disclosure allow the production units to generate parameters for treating the relief precursor, not only based on the signals coming from the central control means but also adaptively based on information of each received relief precursor.

Some embodiments of the present disclosure aim to avoid disruption when one production unit is faulty.

Some embodiments of the present disclosure decrease the reliance of the whole production system on a single central control means. Some embodiments of the present disclosure make it possible progressively to choose certain production units according to the state of production, for example through choosing a production unit better suited to continue treating a relief precursor after the relief precursor has been treated by an upstream production unit.

Some embodiments of the present disclosure make it possible for production units previously not belonging to the production system and not compatible with the existing production units to receive nevertheless the instructions from the central control means and/or to interact with the existing production units.

According to a first aspect of the disclosure is a method of controlling a relief plate production system comprising a plurality of production units. The method comprises the steps of:
each of the plurality of production units receiving a job instruction from a central control means and storing said job instruction in a list of job instructions, said job instruction including at least an identifier of a relief plate to be produced from a relief precursor;
after the plurality of production units have received the job instruction, one production unit of the plurality of production units receiving a relief precursor and an indication of the identifier of this relief precursor, and treating the relief precursor in accordance with the received job instruction.

Thanks to these steps the production units can identify each relief precursor according to the identifier. In this way, the decision on how to treat the relief precursor is at least partially decentralised to the production units. The burden on the central control means is relieved. And each production unit can flexibly choose how best to treat the relief precursor based on their own treating properties. The identifier is attributed to the relief precursor at the beginning of the process and serves as identifier throughout the process and as identifier for the resulting relief plate.

In addition, the central control means sends the job instruction to each production unit. In this way it is no longer needed to tailor the job instruction to each production unit. Instead, it is now the production units that decide the parameters to treat the relief precursor based on the identifier of the relief precursor in addition to the job instruction from the central control means.

Sending the job instructions may be achieved via a wire, wireless, electromagnetic radiation, a local or non-local network or combinations thereof. More in particular any short-range or long-range communication means may be used between the central control means and the production units and/or amongst the production units themselves, such as WiFi, cellular, Zigbee, etc.

It is further noted that the central control means may be provided in a distributed manner in the cloud, and/or may be provided in a local device.

Typically, the identifier comprises a unique identifier such as a time stamp or a steadily increasing number. The unique identifier may comprise an object identifier as described in ITU-T Rec X.667 or ISO/IEC 9834-8:2005.

Preferably, the job instruction further comprises one or more plate related parameters, such as the type of plate, the thickness of plate, or the size of plate. Using such plate related parameters, a production unit may select the appropriate configuration settings for the treatment by the respective production unit.

Optionally, the job instruction may further include a customer identifier. In that way, a production unit may select configuration settings according to the wishes of a specific customer. For example, for a first plate type a different configuration setting may be selected for a first and second customer. To that end, a production unit typically stores configurations settings for different types of plates and for different customers.

Optionally, the job instruction may further include an image of the job. This allows an operator to easily recognise and/or select a job instruction from a list of job instructions stored on the production unit.

The first aspect of the disclosure may comprise any one of or any technically possible combinations of the following features:

The method further comprises, after or before the one production unit has treated the relief precursor, another production unit of the plurality of production units receiving a relief precursor and an indication of the identifier of this relief precursor and treating the relief precursor in accordance with the received job instruction.

With these features, the relief plate production system can treat at least two relief precursors at the same time based on the received job instructions.

The method further comprises broadcasting by the central control means of the job instruction to the plurality of production units.

Broadcasting here means sending the same job instruction to all the destinations (the plurality of the production units or to all the production units that are able to receive the job instruction from the central control means). With this feature, the burden on the central control means is further reduced for it neither distinguishes the job instruction nor its destinations. Instead, it will be up to the production units to analyse the job instruction if the relief precursor arrives at that production unit. In addition, sending an identical job instruction to the production units eliminates the need to make decisions already when the job instructions are sent from the central control means. Instead, configuration settings for a production unit may be selected by the production unit, e.g. based on a plate related parameter included in the job instruction.

Instead of broadcasting the same job instruction to all units, it is also possible to unicast or multicast of a job instruction to a subset of the plurality of production units. In this way different job instructions may be sent to different subsets (e.g. a first multicast to all imagers, a second multicast to all exposure units, etc.).

The method further comprises sending by the central control means the job instruction upon a request of a production unit of the plurality of production units and/or when a production unit of the plurality of production units is switched on or re-activated, such as when moving from a sleep mode to an active mode.

Under this possibility the central control means does not send out indiscriminately the job instruction. Instead, it only sends out the job instruction when certain condition(s) of the production units is (are) satisfied (here, upon a request and/or switching on).

According to some embodiments, at least one production unit requests from the central control means 50 a list of the job identifiers of all the available jobs. The at least one production unit then compares the list of the job identifiers of the production unit making the request and the list of the job identifiers of all the available jobs received from the central control means 50. The at least one production unit then requests the job instruction of at least one job whose job identifier is on the list of the job identifiers of all the available jobs but missing from the list of the job identifiers of the production unit making the request.

With these features there would be no need to create a job instruction on a production unit. The job instruction may be created partially or fully centrally on the central control means and/or partially or fully by an external software means and provided to the central control means. For example, the layouting of the job may be done using an external software package and production unit settings may be added to the job instruction by the central control means. In yet embodiments, it is also possible that the job instruction is created partially by the central control means and partially by the production unit.

Further, instead of requesting full job instructions from the central control means, the production unit only needs to request the job identifiers from the central control means to see which job instructions it does not yet have. In this way the computational cost of the production unit and/or the central control means is reduced.

The request is for example made by the production unit on a regular basis.

According to some embodiments at least one production unit compares the list of the job identifiers of the production unit making the request and the list of the job identifiers of all the available jobs received from the central control means 50. If the production unit notices that there is a job for which the production unit has the job instruction, but its corresponding job identifier is not in the list of the job identifiers received from the central control means 50, this production unit will remove the job instruction whose job identifier is not on the list of the job instructions received from the central control means 50. In this manner, the job instructions on the production unit are synchronised with the job instructions available in the central control means 50.

The plurality of production units comprises a set of production units, and the one production unit is one of the set of production units, wherein preferably the production units in the set perform substantially the same function in plate production; the method further comprising removing the job instruction from the list of job instructions stored on any other production unit of the set of production units which have not received the relief precursor.

The removal of the job instruction from other production units of the set makes sure that the relief precursor would not be treated again by another production unit in the same set and avoids that jobs are kept stored unnecessarily in a production unit. This is particularly advantageous when the production units in the set perform substantially the same function. The production units in the same set are at the same level in the production process, and with one production unit treating the relief precursor this relief precursor will not be treated again in a similar way by another production unit of the same set.

The method comprises sending a message M1 by the one production unit to any other production unit of the set, either directly or through the central control means, indicating that the one production unit has treated the relief precursor or has started treating the relief precursor or has received the relief precursor.

This message M1 informs the other production units in the set that the relief precursor is under the responsibility of the one production unit. This message M1 for example informs the other production units in the set that this relief precursor will not be under their responsibility in the treatment. This message M1 can comprise the instruction, which orders the other production units in the set to delete their job instructions.

The method further comprises sending by the one production unit a message M2 to the other production unit, either directly or through the central control means, indicating that the relief precursor treated by the one production unit is ready to be treated by the other production unit, and optionally displaying the job instruction for the relief precursor on a display of the other production unit.

With these features, the one production unit can communicate with the other production unit. The other production unit is made aware that the treatment by the one production unit has ended or will end in the near future. The other production unit may then take any appropriate action such as display the job on a display of the other production unit so that an operator can easily select the job, include the job in a time schedule, etc.

According to a second aspect of the disclosure is a method of controlling a relief plate production system comprising a plurality of production units including at least a first production unit, and a set of second production units directly downstream of the first production unit, wherein preferably the second production units in the set perform substantially the same function in plate production. The method comprises the steps of:
receiving at the first production unit a job instruction and storing said job instruction in a list of job instructions, said job instruction including at least an identifier of a relief plate to be produced from a relief precursor;
receiving a relief precursor and an indication of the identifier at the first production unit and treating said relief precursor in accordance with the received instruction;
removing the job instruction from the first production unit;
sending by the first production unit a second job instruction to the set of second production units, said second job instruction including at least the identifier;
receiving the treated relief precursor at one of the set of second production units and further treating said relief precursor in accordance with the received second job instruction;
removing the second job instruction from all second production units of the set.

Thanks to these features, the job instruction is sent from to the first production unit to the second production units. It is therefore possible for the first production unit to feed information on the state of plate production into the second production units. Compared to the situation where the second production units simply follow the instruction they received before the first production unit has finished treating the relief precursor, under the second aspect the job instruction to the second production units is more closely tailored to the current plate production progress. The identifier is attributed to the relief precursor at the beginning of the process and serves as identifier throughout the process and as identifier for the resulting relief plate.

The second aspect of the disclosure may comprise any one of, or any technically possible combinations of the following features:

The sending comprises sending by the first production unit the job instruction to all production units downstream of the first production unit, or only to the set of second production units directly downstream of the first production unit.

When the first production unit sends the job instructions to all the production units downstream of it, it assumes a central role in controlling the plate production system. When the first production units only send the instruction to the second production units directly downstream of it, the total number of possible job instructions sent by the first production unit is reduced, decreasing the resource requirements on the first production unit. In addition, this leaves open the possibility that one of the second production units can send its own job instruction to some production units further downstream of this second production unit.

The method further comprises sending a message M1 by the one second production unit to any other second production unit of the set, when the one second production unit has treated the relief precursor or has started treating the relief precursor or has received the relief precursor, to remove the second job instruction, whereupon the other second production unit removes the second job instruction from a list of job instructions.

Under these features it is possible for one second production unit which has received the job instruction to inform other second production units in the set that the former is in charge of the treatment in this set, and the latter would not be needed in the treatment of this specific relief precursor. This gives certainty to the other second production units. This also frees up computational resources in the other second production units.

The method further comprises, after receiving the relief precursor at the one second production unit, reading the indication of the identifier by the one second production unit, and retrieving the second job instruction from a memory of the one second production unit based on the read indication. The memory of the second production unit may be located in the second production unit or may be located in a different device or in the cloud.

With these features the second job instruction is stored locally in the memory of the second production unit. The second job instruction does not come completely from an external entity (either completely from the first production units or completely from the central control means). The volume of information sent to the second production units is therefore reduced. In addition, by reading the indication of the identifier the second production units can determining on its own the parameters to be used to treat the relief precursor without relying entirely on information received outside.

The first production unit is part of a set of first production units, wherein preferably the first production units in the set perform substantially the same function in plate production. The method comprises:
receiving the job instruction at all first production units of the set;
sending a message by the first production unit to any other first production unit of the set, when the first production unit has treated the relief precursor or has started treating the relief precursor or has received the relief precursor, to remove the job instruction, whereupon the other first production unit removes the job instruction from a list of job instructions.

Under these features it is possible for the first production unit which sends out the instruction also to inform other first production units that the former is in charge of treating the relief precursor and the latter are not needed in the treatment of these specific relief precursor. This frees up computational resources in the other first production units.

According to some embodiments the first production unit is an exposure unit, and the set of second production units is a set of development units.

The job instruction is received at the first production unit from an imaging unit or from a central control means.

Under this feature the first production unit is either controlled by another unit in the plate production process upstream of the first production unit, or by a central control means which is not a production unit in the plate production process.

The imaging unit is part of a set of imaging units, the method comprising receiving at the set of imaging units the job instruction from the central control means. The imaging unit may then send in turn the job instruction to the first production unit.

According to a third aspect of the disclosure is a method of controlling a relief plate production system, the relief plate production system comprising:
a plurality of production units comprising at least one connected production unit and at least one unconnected production unit. The at least one connected production unit is configured to communicate with a central control means and/or with another connected production unit. The at least one unconnected production unit is unable to communicate with the central control means and/or with the at least one connected production unit; and
a mobile device configured to communicate with the central control means and/or with the at least one connected production unit.
the method comprises the steps of:
   the mobile device receiving a job instruction, said job instruction including at least an identifier of a relief plate to be produced from a relief precursor;
   one unconnected production unit of the at least one unconnected production unit receiving a relief precursor and an indication of the identifier of this relief precursor, and treating the relief precursor in accordance with the received job instruction,
   sending by the mobile device a message to the central control means and/or to a connected production unit of the at least one connected production unit, said message indicating that the relief precursor has been or will be treated by the one unconnected production unit.

Thanks to these features other production units and/or the central control means can send job instructions to the mobile device. When an unconnected production unit needs to be included in an existing production system, there will no longer be the need to carry out complicated integration of this unconnected production unit. Instead, it suffices to use the mobile device, which emulates the unconnected production device in the production system. This simplifies the inclusion of any production unit previously unrecognised to the existing production system into the existing production system.

The third aspect of the disclosure may comprise any one of, or any technically possible combinations of the following features:

The relief plate production system comprises at least two connected production units, the at least two connected production units being able to communicate with each other, either directly or through a central control means.

The method further comprises entering by an operator an input derived from the job instruction received on the mobile device, into the unconnected production unit.

Under this feature the operator acts as the bridge between the unconnected production unit and the mobile device. These reduces the need to modify the connected production units already in the system to accommodate the unconnected production unit. It also reduces the need to modify the unconnected production unit to be integrated into the existing system.

The method further comprises entering by an operator an input into the mobile device to indicate that a relief precursor has been or will be treated by the unconnected production unit.

The mobile device can then communicate this input to other connected production units and/or the central control means if present. The other connected production units can in this way be made aware of the status of the unconnected production unit.

The relief plate production system comprises a central control means, the central control means sending the job instruction to the mobile device and sending the job instruction directly to the at least one connected production unit without the intermediary of the mobile device.

The method further comprises sending by the mobile device the job instruction to at least one connected production unit of the at least one connected production unit downstream of the unconnected production unit.

Under these features the mobile device does not only receive job instructions. It also gives job instructions to at least one connected production unit. In particular, by sending the job instruction to a connected production unit downstream of the unconnected production unit the mobile device makes it possible that the status of the unconnected production unit can influence the treatment downstream of it even if the unconnected production unit itself cannot communicate with the connected production units.

Each of the first, the second, and the third aspect of the disclosure may comprise any one of, or any technically possible combinations of the following features:

The job instruction includes one or more look-up parameters for looking up one or more configuration parameters stored at the production unit. The one or more look-up parameters may include at least one of the following: a type of precursor, a thickness of the precursor, information on a size of the precursor, a client identifier.

Such one or more look-up parameters allow the production unit to look-up suitable configuration settings for performing the job.

The job instruction includes a reference to a preview image or a preview image.

The method further comprises, preferably prior to the receiving of a job instruction at a respective production unit, receiving the preview image at the respective production unit and displaying the preview image together with the job instruction at the respective production unit.

In this way, a preview image may be displayed on a display of the production unit so that an operator can more easily recognise and/or choose a job.

The job instruction includes a reference to one or more image files to be used by a production unit, such as an imaging unit, and/or an imaging setting to be used by the imaging unit.

The plurality of production units comprises an imaging unit. The method further comprises, preferably prior to the receiving of a job instruction at the imaging unit, receiving the one or more image files at the imaging unit.

The image files are sometimes relatively large in size. By only sending the image files to the imaging units instead of all the production units less connection and/or storage resources are used.

The job instruction includes, e.g. in its file name, a time stamp, e.g. including a date and a time, and optionally a name chosen by a creator of the file.

The method further comprises the production unit displaying a set of job instructions received at the respective production unit in an ordered manner, based on the time stamp of the set of job instructions.

The plurality of production units comprises an imaging unit. The indication of the identifier is generated in the relief precursor by the imaging unit.

With these features the imaging unit creates the indication, optionally based information input by an operator or on information from the central control means. An image indication has the advantage of being robust so that it can be kept well readable even after a number of treatments in the various production units.

The plurality of production units comprises at least a first set of productions unit upstream of a second set of productions units, wherein production units of the same set preferably have substantially the same function.

The plurality of production units comprises any one of the following: a transport unit, a pre-processing unit, an imaging unit, an exposure unit, a development unit, such as a washer or a thermal development unit, a post-processing unit, such as a dryer, a post-exposure unit, such as a cutting unit configured to cut the plate, a mounting unit configured to mount the relief precursor onto a sleeve or another substrate, a storage unit.

The method further comprises an operator reading the indication of the identifier and selecting a corresponding job from the list of jobs stored in a production unit of the plurality of production units, which has received the relief precursor.

The method further comprises the production unit reading the indication of the identifier and selecting a corresponding job from the list of jobs stored in a production unit of the plurality of production units, which has received the relief precursor.

By having the operator and/or the production unit selecting the job based on the indication of the identifier the production unit can use the most appropriate parameters to treat the relief precursor passing through it. In addition the order of jobs may be influenced e.g. in order to process a certain job with a higher priority.

The identifier is attached or integrated to the relief precursor or to a carrier, such as a trolley, carrying the relief precursor.

A production unit of the plurality of production units has a display, and the method further comprises displaying a subset of the job instructions received at said production unit, said subset corresponding with jobs which have been treated or are being treated by a production unit directly downstream of said production unit and which can be performed by said production unit.

Thanks to these features only the jobs that can be carried out or are being carried out by the production unit are displayed. The display does not show the jobs which cannot be performed by the production unit in question and consequently prevents the job that cannot be performed by this production unit from being chosen.

Said subset includes jobs for which a message (M2) has been received from a downstream production unit directly downstream of the respective production unit to indicate that the relief precursor has been or will be processed by the downstream production unit.

With these features whether the received job instruction will be displayed depends not only on the production unit which has received the job instruction, but also a downstream production unit downstream of the production unit.

The plurality of production units comprises at least a set of productions unit having substantially the same main function but different optional functions, and a received job instruction is only displayed on a production unit having suitable optional functions.

These features make sure that when the received job instruction requires some optional functions only present on some production units, only those production units having the optional functions will be ordered to carry out the job instruction.

Any feature of any one aspect of the present disclosure can be combined with any feature of any other aspect(s) of the present disclosure.

The present disclosure also concerns a central control means configured for controlling a relief plate production system, preferably for use in a method as described above, comprising a plurality of production units. The central control means is configured for transmitting to each of the plurality of production units a job instruction, said job instruction including at least an identifier of a relief plate to be produced from a relief precursor.

The central control means may comprise any one of, or any technically possible combinations of the following features:

The transmitting comprises broadcasting the job instruction.

The transmitting comprises transmitting the job instruction upon receiving a request of a production unit of the plurality of production units and/or when detecting that a production unit of the plurality of production units is switched on or re-activated.

The central control means is further configured to receive a message when a respective production unit of the plurality of production units will start or has started or has finished a job corresponding with a job instruction, and, in response, at least one of:
to inform at least one other production unit which no longer has to perform the job, to remove the job instruction;
to inform at least one other production unit downstream of the respective production unit that the respective production unit will start or has started or has finished the job corresponding with the job instruction.

The job instruction includes one or more look-up parameters for looking up one or more configuration parameters stored at the production unit, wherein preferably the one or more look-up parameters include at least one of the following: a type of the precursor, a thickness of the precursor, information on a size of the precursor, a client identifier.

The job instruction includes a reference to a preview image, and the central control means is configured to transmit, preferably prior to the transmitting of the job instruction, the preview image.

The job instruction includes a reference to one or more image files to be used by a production unit, such as an imaging unit, and/or an imaging setting to be used by the imaging unit, and the central control means is configured to transmit to the imaging unit, preferably prior to the transmitting of the job instruction, the one or more image files.

The central control means is configured to generate the job instruction so that it includes, e.g. in its file name, a time stamp, e.g. including a date and a time, and optionally a name chosen by a creator of the file.

The central control means is configured to keep track of jobs corresponding with job instructions transmitted to the plurality of productions units and maintains a database storing for each job instruction which one or more production units have performed the job and/or are scheduled to perform the job, optionally together with time data related to when the job has been performed or when it is scheduled to be performed.

The present disclosure also concerns a production unit of a relief plate production system, preferably for use in a method of any one of the previous claims. Said production unit is configured to receive a job instruction including at least an identifier of a relief plate to be produced from a relief precursor, to store the job instruction in a list of job instructions, to receive a relief precursor and an indication of the identifier of this relief precursor, and to treat the relief precursor in accordance with the received job instruction. The identifier is attributed to the relief precursor at the beginning of the process and serves as identifier throughout the process and as identifier for the resulting relief plate.

The production unit may comprise any one of, or any technically possible combinations of the following features:

The production unit is further configured to send a request to a central control means to receive job instructions potentially intended for the production unit, and, in response, to receive said job instructions from the central control means and to store them and/or the production unit is configured to signal to the central control means that it is switched on or re-activated, and, in response to receive said job instructions and store them.

The production unit is further configured to transmit, when the production unit will start or has started or has finished a job corresponding with a job instruction, at least one of:
a message to inform at least one other production unit which no longer has to perform the job, to remove the job instruction;
a message to inform at least one other production unit downstream of the production unit that the production unit will start or has started or has finished the job corresponding with the job instruction.

The job instruction includes one or more look-up parameters for looking up one or more configuration parameters stored at the production unit, wherein preferably the one or more look-up parameters include at least one of: a type of the plate, a thickness of the plate, information on a size of the plate, a client identifier, and the production unit is configured to set one or more configuration parameters based on the one or more look-up parameters.

The job instruction includes a reference to a preview image or a preview image. The production unit is configured to receive, preferably prior to the receiving of the job instruction, the preview image, and to display the preview image together with the job instruction.

The production unit is an imaging unit, and the job instruction includes a reference to one or more image files to be used by the imaging unit, and/or an imaging setting to be used by the imaging unit, and the imaging unit is configured to receive, preferably prior to the receiving of the job instruction, the one or more image files.

The imaging unit is configured to generate, preferably image, the indication of the identifier in the relief precursor based on the received job instruction.

The job instruction includes, e.g. in its file name, a time stamp, e.g. including a date and a time, and optionally a name chosen by a creator of the file, and the production unit is configured to display a list of the received job instructions in an orderly manner based on the time stamps thereof.

The production unit is further configured to transmit the received job instruction to one or more other production units downstream of the production unit.

The production unit is or comprises any one of the following: a transport unit, a pre-processing unit, an imaging unit, an exposure unit, a development unit, such as a washer or a thermal development unit, a post-processing unit, such as a dryer, a post-exposure unit, such as a cutting unit configured to cut the plate, a mounting unit configured to mount the relief precursor onto a sleeve or another substrate, a storage unit.

The production unit is further configured to read the indication of the identifier of a received relief precursor and select a corresponding job from the list of jobs stored in the production unit.

The production unit further comprises a display and further configured to display a subset of the job instructions received at the production unit, said subset corresponding with jobs which have been treated or are being treated by another production unit directly downstream of said production unit and which can be performed by the production unit.

Said subset includes jobs for which a message (M2) has been received from another production unit directly downstream of the production unit to indicate that the relief precursor has been or will be processed by the downstream production unit.

The present disclosure also concerns a relief plate production system comprising a central control means as described above and a plurality of production units as described above.

### BRIEF DESCRIPTION OF THE DRAWINGS

The above and further aspects of the disclosure will be explained in more detail below on the basis of a number of embodiments, which will be described with reference to the appended drawings. In the drawings:

FIG. 1 shows a basic embodiment according to the first aspect of present disclosure.

FIG. 2 shows a more complete embodiment according to the first aspect of the present disclosure.

FIG. 3 shows another embodiment according to the first aspect of the present disclosure, the embodiment in FIG. 3 having fewer production units then the one in FIG. 2.

FIG. 4 shows another embodiment according to the first aspect of the present disclosure, the embodiment to FIG. 4 having fewer production units than the one in FIG. 3.

FIG. 5 shows an embodiment according to the first aspect of the present disclosure, showing the removal of some job instructions from certain production units. FIG. 5 also shows the communication between certain production units with its downstream production units.

FIG. 6 shows an embodiment similar to the one in FIG. 5, the removal of some job instructions is made via the central control means.

FIG. 7 shows an embodiment according to the second aspect of the present disclosure, the most upstream production unit sending job instructions to all the downstream production units.

FIG. 8 shows an embodiment similar to the one in FIG. 7, having two most upstream production units receiving the job instructions from a central control means with one of the most upstream production units then sending the job instructions to its downstream production units.

FIG. 9 shows an embodiment according to the second aspect of the present disclosure, the upstream production unit sending the job instruction to the production units directly downstream of the upstream production unit.

FIG. 10 shows an embodiment according to the third aspect of the present disclosure.

FIG. 11 shows a variant to the embodiment in FIG. 10, the mobile device sending the job instruction to the production units downstream of the unconnected production unit.

FIG. 12 shows some examples of the content of a job instruction.

FIG. 13 shows a flow chart when a production unit only displays a subset of the received job instructions corresponding to the jobs which can or are ready to be performed by this production unit.

### DESCRIPTION OF THE INVENTION

Flexographic printing or letterpress printing are techniques which are commonly used for high volume printing. Flexographic or letterpress printing plate are relief plates with printing elements, typically called reliefs or dots, protruding above non-printing elements in order to generate an image on a recording medium such as paper, cardboard, films, foils, laminates, etc. Also, cylindrically shaped printing plates or sleeves may be used.

Various methods exist for making flexographic printing plate precursors. According to conventional methods, flexographic printing plate precursors are made from multilayer substrates comprising a backing layer and one or more photocurable layers (also called photosensitive layers). Those photocurable layers are imaged by exposure to electromagnetic radiation through a mask layer containing the image information or by direct and selective exposure to light e.g. by scanning of the plate to transfer the image information in order to obtain a relief plate.

The relief precursor for example comprises a mask layer, a substrate layer, and a photosensitive layer placed between the mask layer and the substrate layer. The relief precursor is an imaged relief precursor before its exposure to electromagnetic radiation which cures a portion of the photosensitive layer. The relief precursor is for example a digital relief precursor or an analogue relief precursor. In case of a digital relief precursor the mask layer is an integral layer of the precursor, and the imaging of the mask layer results in an ablated layer, whereas in case of an analogue relief precursor the mask layer is typically a separate layer, such as a film, which comprises areas which are transparent for radiation and areas which are not transparent for radiation, and which is mounted onto the relief precursor prior to exposure with electromagnetic radiation. For example, a non-transparent ablatable layer on a substrate layer may be used and the structures may be generated by ablation, or the transmission of a layer of a film may be changed by exposure with a laser.

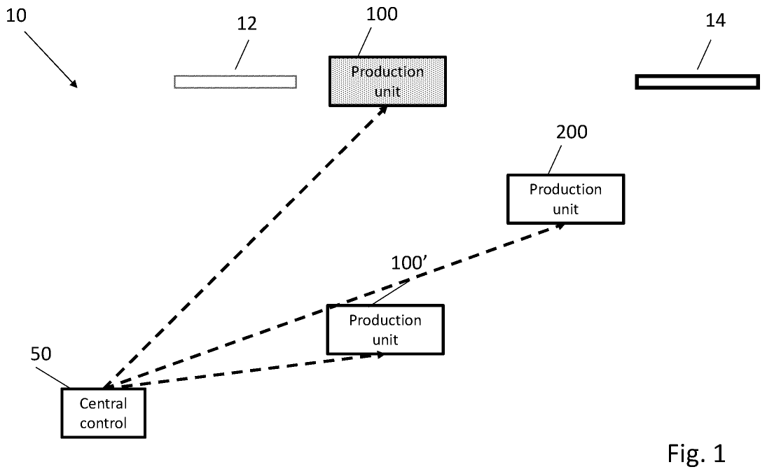

FIGS. 1 to 4 show some embodiments according to the first aspect of the present disclosure.

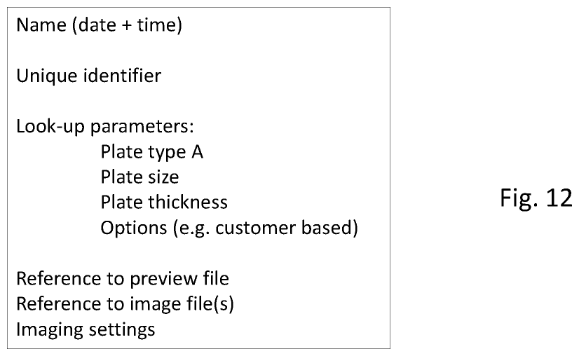

FIG. 1 shows one of the most basic embodiment under the first aspect of the present disclosure. FIG. 1 shows a relief plate production system 10. The relief plate production system 10 comprising a plurality of production units 100, 100′, 200. The plate production system 10 also comprises at least a central control means 50 configured to control the plurality of production units 100, 100′, 200. According the first aspect of the present disclosure, first each of the plurality of production units 100, 100′, 200 receives a job instruction from the central control means 50. The job instruction includes at least an identifier of a relief plate 14 to be produced from a relief precursor 12. The content of the job instruction will be described in detail with reference to FIG. 12.

After the plurality of production units 100, 100′, 200 have received the job instruction, one production unit 100 of the plurality of production units 100, 100′, 200 receives a relief precursor 12 and an indication of the identifier of this relief precursor 12. The one production unit 100 then treats the relief precursor 12 in accordance with the received job instruction. After the treatment by the one production unit 100 the relief precursor 12 may already become the relief plate 14, or may require additional treatment before it becomes the relief plate 14.

Although FIG. 1 shows that the production unit 100 receives the relief precursor 12 and performs the treatment in accordance with the received the job instruction, it is equally possible that it is the production unit 100′, or the production unit 200 that receives the relief precursor 12 instead of or in addition to the production unit 100. For example, after or before the one production unit 100 has treated the relief precursor 12, another production unit 100′, 200 of the plurality of production units 100, 100′, 200 receives a relief precursor 12 and an indication of the identifier of this relief precursor 12. The another production unit 100′, 200 then treats the relief precursor 12 in accordance with the received job instruction. The job instruction received by the another production unit 100′, 200 maybe the same as or different from the job instruction received by the one production unit 100.

According to some embodiments the indication of the identifier can be received by different production units at different moments but all before any treatment by any production unit has started.

Generally in the figures of this application the production units that receive the relief precursor 12 are shadowed.

The plurality of production units 100, 100′, 200 may perform substantially the same treatment to the relief precursor 12. Alternatively, at least one of the production units 100, 100′, 200 may perform a treatment different from that carried out by the other production units.

According to some embodiments such as those shown in the FIGS. 1-4 and 10, the method comprises broadcasting by the central control means 50 of the job instruction to the plurality of production units 100, 100′, 200. Broadcasting here means sending the job instruction to all the production units, preferably means sending the same job instruction to all the production units.

According to some embodiments, the broadcast job instruction is not displayed on the production units.

According to some embodiments, the method further comprises sending by the central control means 50 the job instruction upon a request of a production unit 100 of the plurality of production units 100, 100′, 200 and/or when a production unit 100 of the plurality of production units 100, 100′, 200 is switched on or re-activated. For the latter case when the production unit in question is switched on it may send a message to the central control means 50 to inform the latter. Alternatively, the central control means 50 detects when the production unit 100 in question is available without any message from the production unit 100. According to some embodiments when at least a production unit requests the job instruction from the central control means 50 the job instruction sent to the at least one production unit is identical. According to some embodiments when at least two production units request the job instructions from the central control means 50 the job instructions are sent simultaneously.

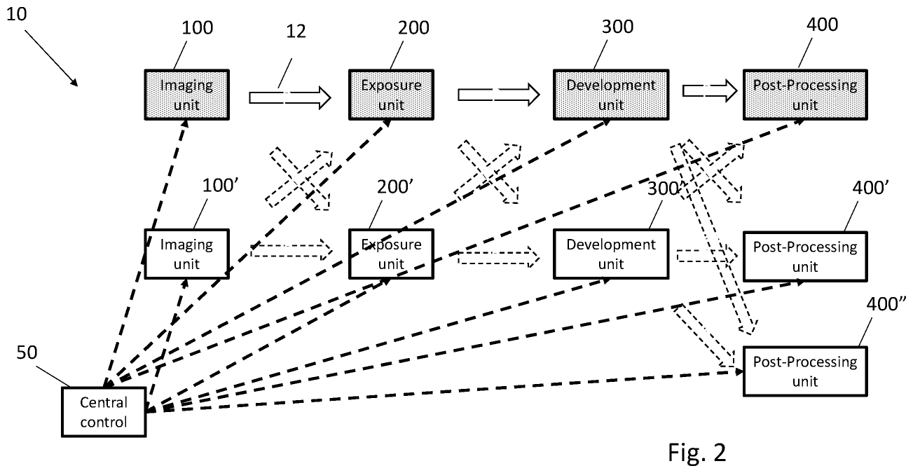

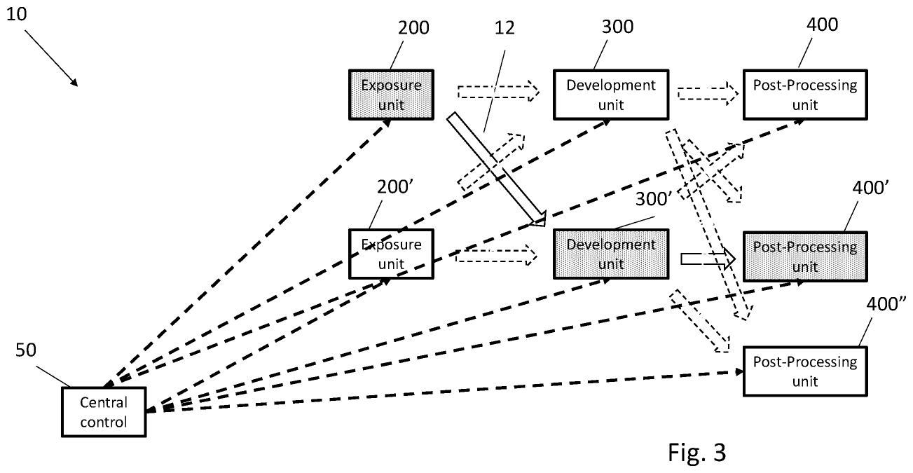

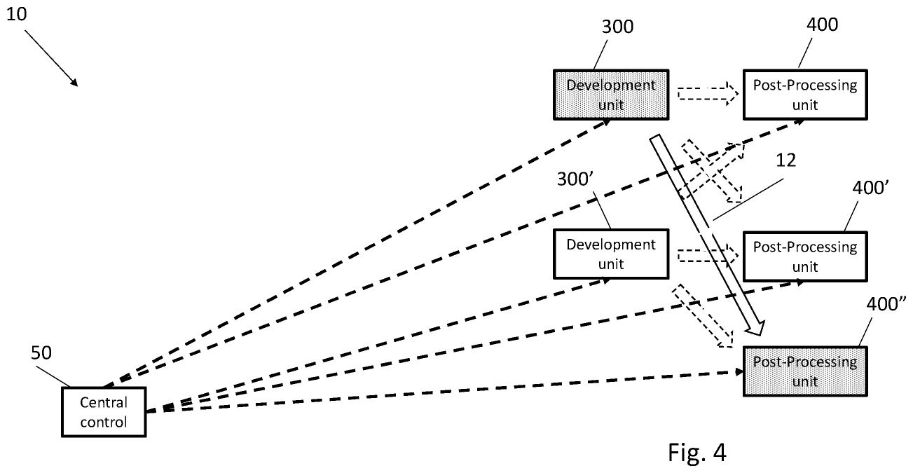

The embodiments in FIGS. 2 to 4 show that the plurality of production units comprises at least a set of production units 200, 200′; 300, 300′; 400, 400′, 400″. The one production unit 200; 300′; 400 is one of a set of production units 200, 200′; 300, 300′; 400, 400′, 400″. Preferably, the production units in the same set perform substantially the same function in plate production. According to the embodiment in FIG. 4, the set of production units comprises a set of development units 300, 300′ and a set of post-processing units 400, 400′, 400″ downstream of the set of development units 300, 300′. According to the embodiment in FIG. 3, the set of production units further comprises, in addition to the sets in FIG. 4, a set of exposure units 200, 200′ upstream of the set of development units 300, 300′. According to the embodiment in FIG. 2, in addition to the sets in FIG. 3 the production system 10 further comprises a set of imaging units 100, 100′ upstream of the set of exposure units 200, 200′.

The imaging units 100, 100′ are configured to image a mask layer; e.g. an imager comprising means to generate and control at least one beam of electromagnetic radiation. The imager may be a flatbed device or an inner or outer drum device, the latter may be equipped with a rotating drum. The imaging units 100, 100′ are configured to image the mask layer on the precursor 12 using the converted image file and/or imaging instructions generated by a control module, for example by the central control means 50.

According to various aspects of the disclosure the indication of the identifier is generated in the relief precursor 12 by the imaging unit 100, 100′. The content of the identifier will be explained below in reference to FIG. 12. According to some embodiments the identifier is already visible to human eyes even before the relief precursor 12 is exposed by an exposure unit 200, 200′.

The identifier is for example attached or integrated to the relief precursor 12. Alternatively, the identifier is attached or integrated to a carrier, such as a trolley, carrying the relief precursor. The carrier is for example linked to the production units wirelessly. Alternatively the trolley may have a plurality of screws each able to occupy at least two positions. Through the combination of the screws' positions information on the precursor type on the trolley can be obtained. For example, there are three screws on the trolley and each screw has two positions. In this setup the screws can have eight possible combinations in total which can represent eight plate types. According to some embodiments the trolley can be identified for example by an RFID tag.

The exposure units 200, 200′ are configured to expose the precursor 12 to electromagnetic radiation so that a portion of the photosensitive layer is cured. The electromagnetic radiation may have a wavelength in the range of 200 to 2000 nm, preferably it is ultraviolet (UV) radiation with a wavelength in the range of 200 to 450 nm. The electromagnetic radiation changes the properties of the exposed parts of the photosensitive layer such that in the following development units 300, 300′ non-exposed portions of the photosensitive layer are removed by the development units. A flat or cylindrical relief printing plate may be formed.

The development units 300, 300′ are configured to develop the exposed relief precursor by removing a portion of the photosensitive layer that was not exposed to the electromagnetic radiation and that is therefore not cured. A skilled person is familiar with various ways of exposing the relief precursor 12 to electromagnetic radiation, and of developing an exposed relief precursor including wet processes using water, aqueous solutions or solvents or dry processes using thermal treatment and removal of liquefied material by suction, blowing, particle beams, adsorbance or absorbance to a developing material.

The post-processing units 400, 400′, 400″ are configured to carry out a treatment after the relief plate is developed by the development unit 300, 300′. Such post-possessing may be exposure to electromagnetic radiation (e.g. UV light), to liquids or gases or combinations thereof.

More generally the plurality of production units comprises any one of the following: a transport unit, a pre-processing unit, an imaging unit, an exposure unit, a development unit, such as a washer or a thermal development unit, a post-processing unit, such as a dryer, a post-exposure unit, such as a cutting unit configured to cut the plate, a mounting unit configured to mount the relief precursor onto a sleeve or another substrate, a storage unit. The pre-processing unit can comprise any production unit that carries out a treatment before imaging and/or exposing. The post processing unit can comprise any production unit that carries out a treatment after the relief plate development.

According to some embodiments a production unit 100, 100′; 200, 200′; 300, 300′; 400, 400′, 400″ can store locally in its memory the job instructions that it has received. In addition or alternatively, a production unit 100, 100′; 200, 200′; 300, 300′; 400, 400′, 400″ can store a list of jobs that can be carried out by this production unit. Each job on the list for example corresponds to at least the one treatment parameters which this production units can provide to a relief precursor 12. Treatment parameters may be one or more of the following and may be combined in any possible combination: imaging resolution, size of imaging area, imaging beam size, imaging beam form, imaging beam intensity, number of beams, speed of imaging (rotation speed), presence and/or location and/or type of surface screening, vacuum level, focus information such as in focus or out focus, partial exposure (for example, only a part of the image file is imaged), transport means (e.g. carrier, trolley, endless belt, robotic arm), transport direction, transport start and/or end, transport speed, transport orientation, exposure time, exposure intensity, exposure speed, size of exposed area, exposure cycles, exposure profiles, wavelength of electromagnetic radiation for exposure, dose of exposure, distance of light source from precursor, type of development (e.g. solvent water or thermal), developing conditions, relief depth, floor height, developing time, developing speed, developing temperature, developing liquid, developing material, developing cycles, drying method, drying time, drying temperature, drying location, post exposure wavelength, post exposure time, post exposure intensity, post exposure location, storage location, storage time, storage temperature, cutting information, cutting marks, cutting lines, registration marks.

As shown in the FIGS. 2 to 4, the central control means 50 may send the job instruction to all of the development units 300, 300′. The central control means 50 may send the job instruction to all the post-processing units 400, 400′, 400″. The central control means 50 may send the job instruction to all the exposure units 200, 200′. The central control means 50 may send the job instruction to all the imaging units 100, 100′.

According to some embodiments, the central control means 50 unicasts/multicasts different job instructions to different sets of production units. For example, the central control means 50 multicasts a first job instruction to one or all the imaging units 100, 100′. For example, the central control means 50 multicasts a second job instruction to one or all the exposure units 200, 200′. For example, the central control means 50 multicasts a third job instruction to one or all the development units 300, 300′.

According to some embodiments, the image files may be unicast/multicast only to the imaging unit(s) 100, 100′ and not to all the production units.

Preferably, the relief precursor 12 can move from any one production unit in one set of production units to any one production unit in another set of production units. For example, the relief precursor 12 can move from any imaging unit of the set of imaging units 100, 100′ to any exposure unit of the set of exposure units 200, 200′. For example, the relief precursor 12 can move from any exposure unit of the set of exposure units 200, 200′ to any development unit of the set of development units 300, 300′. For example, the relief precursor 12 can move from any development unit of the set of development units 300, 300′ to any post-processing unit of the set of post-possessing units 400, 400′, 400″. In the figures, the hollow arrows with the solid line represent the way in which the relief precursor 12 actually travelled, and the hollow arrows with the dashed line represent the ways in which a relief precursor 12 can but has not actually travelled.

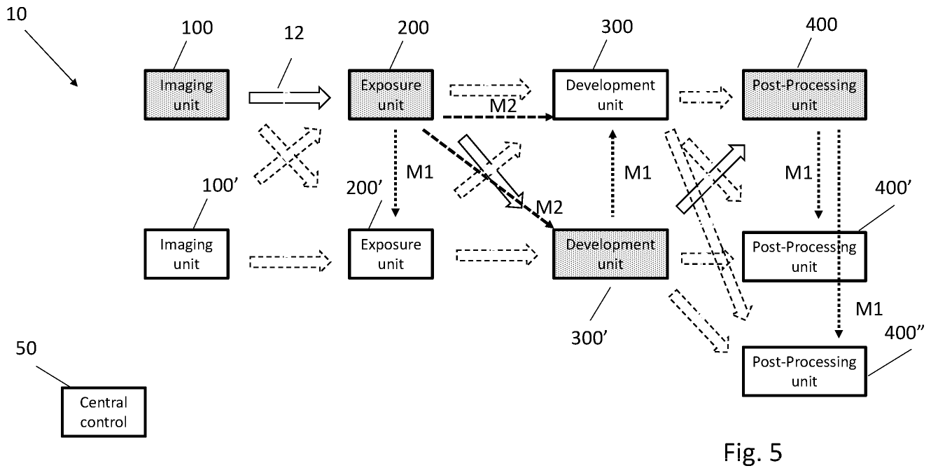

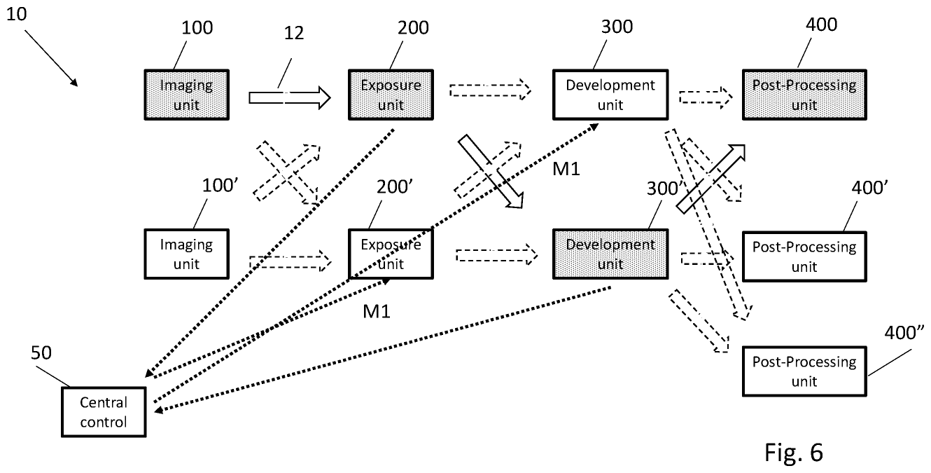

According to some embodiments, such are those represented in FIGS. 5 and 6, the method further comprises removing the job instruction from any other production unit of the set of production units which has not received the relief precursor 12. As presented in FIG. 5, the upper exposure unit 200 in the set of exposure units 200, 200′ has received the relief precursor 12. The job instruction sent to the lower exposure unit 200′, which has not received the relief precursor 12, of the set of exposure units 200, 200′, is removed. In a similar way, the lower development unit 300′ in the set of development units 300, 300′ has received the relief precursor 12. The job instruction sent to the upper development unit 300, which has not received the relief precursor 12, of the set of development units 300, 300′, is removed. The upper post-processing unit 400 has received the relief precursor 12. The job instruction sent to the other post-processing units 400′, 400″, which have not received the relief precursor 12, of the set of post-processing units 400, 400′, 400″, is removed.

According to some embodiments the method comprises sending a message M1 (indicated by a dotted arrow) by the one production unit to any other production unit of the set, either directly (as the case in FIG. 5) or through the central control means 50 (as the case in FIG. 6). The message M1 indicates that the one production unit of the set has treated the relief precursor 12 or has started treating the relief precursor 12 or has received the relief precursor 12. Directly here means sending the message M1 amongst the production units of a set without going through a central control means. The message M1 is preferably sent from the production unit which has received the relief precursor 12. The message M1 for example contains the instruction to the other production units of the set to remove the job instruction which they have received.

According to some embodiments, such as the one shown in FIG. 5, the method further comprising sending by the one production unit a message M2 (indicated by a dashed arrow) to the other production unit, either directly or through the central control means 50. The message M2 indicates that the relief precursor treated by the one production unit is ready to be treated by the other production unit. The one production unit here may not belong to the same set as the other production unit. The message M2 is preferably sent from the production unit, which has received the relief precursor 12. The message M2 is for example sent from a production unit to another production unit in its downstream. According to some embodiments, the message M2 is sent from a production unit to several or all the production units in its downstream. According to some embodiments, the message M2 is sent to its destination via the central control means 50. In the embodiment in FIG. 5, the messages M2 are sent from an exposure unit 200 to the development units 300, 300′. As an alternative or in addition, the message M2 may be sent from an exposure unit to one or some or all the post-processing units 400, 400′, 400″. Optionally, the method also comprises displaying the job instruction for the relief precursor on a display of the other production unit. The message M2 for example contains the command to display the job instruction on the display of the other production unit.

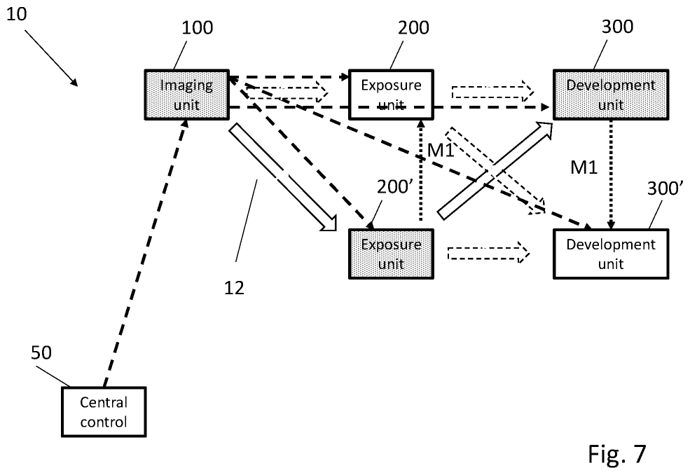

FIGS. 7 to 9 show several embodiments under the second aspect of the present disclosure. The plate production system 10 comprises a plurality of production units. The plurality of production units includes at least a first production unit 100, 100′ and a set of second production units 200, 200′; 300, 300′; 400, 400′, 400″ directly downstream of the first production unit 100, 100′. According to the embodiments in FIGS. 7 to 9 the plurality of production units includes a set of first production units 200, 200′. Preferably, the first and/or second production units in the set perform substantially the same function in a plate production process.

According to some embodiments the first production units 200, 200′ are exposure units. According to some embodiments the second production units 300, 300′ are development units.

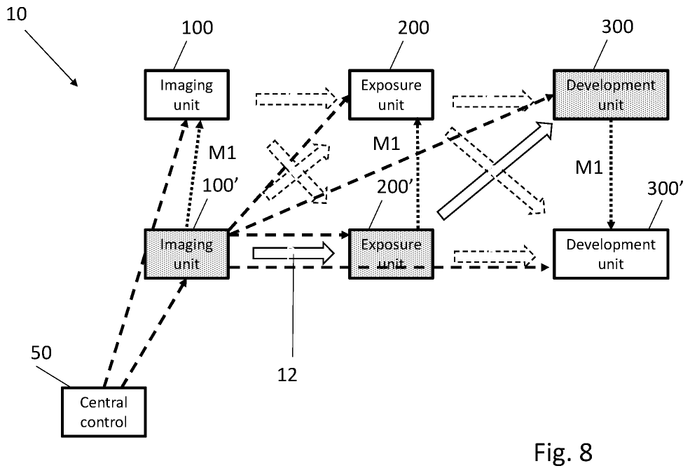

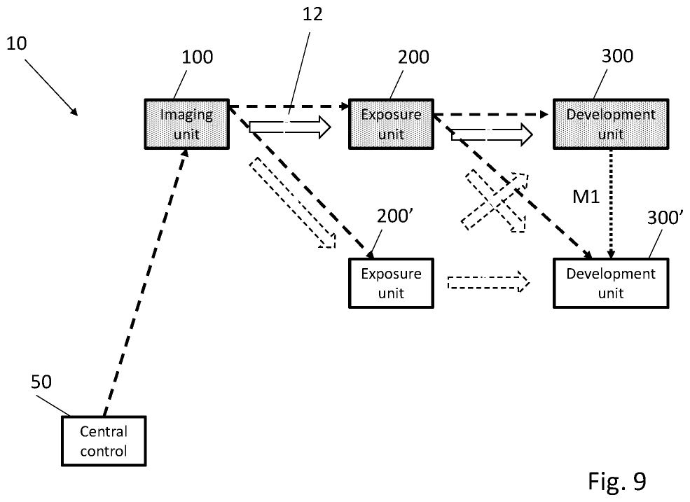

According to the embodiments in FIGS. 7 to 9, the plate production system 10 also comprises at least an imaging unit 100 upstream of the first production unit 200, 200′. The plate production system 10 may comprise one imaging unit 100 (FIGS. 7 and 9) or a set of imaging units 100, 100′ (FIG. 8). Preferably, the imaging units in the set perform substantially the same function in a plate production process.

Under the second aspect of the disclosure, the method comprises first receiving at the first production unit 200, 200′ a job instruction. Said job instruction includes at least a identifier of a relief plate 14 to be produced from a relief precursor 12.

Next, a relief precursor 12 and an indication of the identifier of the relief plate are received at the first production unit 200, 200′. The first production unit 200, 200′ then treats said relief precursor 12 in accordance with the received instruction.

The job instruction is then removed from the first production unit 200, 200′.

According to some embodiments such as those shown in FIGS. 7 and 8, the first production unit is part of a set of first production units 100, 100′; 200, 200′. Preferably the first production units in the set perform substantially the same function in a plate production process. The method for example comprises receiving the job instruction at all the first production units of the set. Then, the method comprises sending a message M1 by the first production unit 100′; 200′ to any other first production unit 100; 200 of the set, when the first production unit 100′; 200′ has treated the relief precursor 12 or has started treating the relief precursor 12 or has received the relief precursor 12, to remove the job instruction. Upon receiving the message M1 the other first production unit 100, 200 removes the job instruction from a list of job instructions. In these embodiments the first production unit may be an imaging unit 100, 100′ and/or an exposure unit 200, 200′ and/or a development unit 300, 300′.

According to some embodiments, the message M1 may be sent to the central control means 50 and the removal of the job instruction from any other production unit of the set is carried out centrally by the central control means 50. In these embodiments even without a message M1 by one production unit to any other production unit of the set, the job instruction of any other production unit of the set can still be removed.

The job instruction is received at the first production unit 200, 200′ from an imaging unit 100, 100′ or from a central control means 50. According to some embodiments such as the one shown in FIG. 8, the imaging unit 100′ is part of a set of imaging units. The method comprises receiving at the set of imaging units 100, 100′ the job instruction from a central control means 50.

Then, the first production unit 200′ sends a second job instruction to the set of second production units 300, 300′. Said second job instruction includes at least the identifier.

According to some embodiments such as the ones in FIGS. 7 and 8, the sending comprises sending by the first production unit 100, 100′ the job instruction to all the production units 200, 200′; 300, 300′ downstream of the first production unit 100, 100′. Alternatively, as shown for example in FIG. 9, the first production unit 100 sends the job instruction only to the set of second production units 200, 200′ directly downstream of the first production unit 100. Under this embodiment, preferably the method further comprises sending by the second production unit 200 a third job instruction to the third production unit 300 directly downstream of the second production unit 200 or to the set of third production units 300, 300′ directly downstream of the second production unit 200. More generally, according to some embodiments under the second aspect of the present disclosure each production unit only sends job instructions to the production unit(s) directly downstream of it. The downstream production unit(s) then send further job instructions to the production units further and directly downstream of the downstream production unit(s) in turn. One example of these embodiment is shown in FIG. 9.

If the second production units 300, 300′ normally receive the job instruction from the first production unit 200, according to some embodiments at least one of the second production units 300, 300′ may seek instruction from the central control means 50 if there is no instruction coming from the first production unit 200. More generally, a production unit can seek instruction from the central control means 50 if there is no job instruction coming from a production unit upstream or directly upstream of it.

According to some embodiments the first production unit 200, 200′ is an exposure unit, and the set of second production units 300, 300′ is a set of development units. Alternatively, the first production unit is an imaging unit 100, 100′, and the second production units are exposure units 200, 200′ or development units 300, 300′. Alternatively, the first production unit is an imaging unit 100, 100′, and the second production units are exposure units 200, 200′, and the third production units are development units 300, 300′.

Afterwards, the treated relief precursor is received at one of the set of second production units 300, 300′. Then said relief precursor is treated in accordance with the received second job instruction by one second production unit 300, 300′.

According to some embodiments, after receiving the relief precursor at the one second production unit 300, 300′, the one second production unit reads the indication of the identifier. The one second production unit then retrieves the second job instruction from a memory of the one second production unit based on the read indication.

According to some embodiments at least one of the production units, under one possibility all the production units, only receives the identifier. The job instruction is stored in the memory of the at least one production unit, under one possibility all the production units.

Finally the second job instruction is removed from all second production units 300, 300′ of the set. According to some embodiments, this step comprises sending a message M1 by the one second production unit 300 to any other second production unit 300′ of the set, when the one second production unit has treated the relief precursor 12 or has started treating the relief precursor 12 or has received the relief precursor 12, to remove the second job instruction. Upon receiving the message M1 the other second production unit 300 removes the second job instruction from a list of job instructions.

According to some embodiments the status of at least one, preferably all the production units in the relief plate production system 10 is updated in real time to the central control means 50, such as whether a job has been started on a production unit or a job has been finished on a production unit. In this way the central control means 50 can keep an accurate track of the jobs corresponding to the transmitted job instructions.

According to some embodiments, after a production unit has received a relief plate precursor 12 and an indication of the identifier of this relief plate precursor 12, this production unit asks the central control means 50 whether it is allowed to start the treatment of the relief plate precursor 12 in accordance with the received job instruction. According to one embodiment, when two operators have selected the same job on two production units, the central control means 50 orders the production unit on which the job is selected earlier to start the job, and asks the production unit on which the job is selected later not to start the job.

According to some embodiments, after the relief plate production system 10 finishes treating a relief plate precursor, at least a parameter of the relief plate, such as the relief depth and/or a dot characteristic of at least an area of the relief plate, is measured. The measured parameter is then sent to the central control means 50. In this manner the central control means 50 is able to record the characteristics of the relief plate made by the relief plate production system 10. The measurement is for example carried out by a production unit which has treated the relief plate precursor, and/or by a measurement unit distinct from the at least one production unit.

Preferably, the measurement data comprises data about a physical property of a treated relief plate precursor, such as a plate thickness, and/or a thickness of a floor of the treated relief plate precursor, and/or measurement data based on a measured printing result such as a lowest stable tonal value produced in the relief plate, and/or a dot gain. The lowest stable tonal value for example is determined through a visual inspection using a microscope on a printed test image which contains fields with different tonal values. The dot gain is for example determined by using a colour densitometer on a printed test image. With these measurement data the relief plate report can provide an accurate indication of the results of the treatments performed on the relief plate precursor, which may help in pinpointing the source of any potential problem on the relief plate.

Additional measurement data concerning the properties of a relief precursor or relief are selected from the group of: thickness of the precursor, thickness of the finished plate, thickness of the floor, depth of the relief, minimum tonal value, tonal value curve, dot gain curve, isolated dot sizes, depth of negative lines, width of positive lines, straightness of lines, depth of negative dots, shape of dots, shoulder angle, roundness of dots (evaluated on a range from round tops to flat tops), intermediate depth of tonal value fields, hardness, surface energy of floor and/or printing features (e.g. using contact angle measurement), elasticity, elastic modulus, curling tendency, anisotropy, roughness, resilience, or combinations thereof.

Optionally, the measurement data comprises production unit related data and/or data related to the environment around a production unit, such as a temperature of the relief plate precursor before and/or during and/or after the treatment, and/or a temperature inside at least one production unit. Such production unit and/or environmental data may further help in analysing and optimising the relief plate manufacturing process. For example, when the quality of the printing results is reduced or increased without having changed the manufacturing process, such parameters may help in understanding where the manufacturing process should be adjusted or better controlled.

Optionally, the measurement data comprises data based on results of printing with the treated plate, optionally further including printing related data such as type of ink, type of printing medium. For example, a client performing the printing process may provide feedback on the quality of the printing results obtained with a certain type of ink and printing medium. Consequently, one could derive more directly whether any potential issue came from the manufacturing of the relief plate itself or rather from a step in the printing process.

Measurements may be performed when the plate is finished but also in between the different treatment steps in the different production units. For example, the method may comprise the step of performing measurements on a plate treated in a production unit of said plurality of production units and transmitting a result of the measurements by said production unit and/or by a computer terminal, preferably a mobile terminal, to the central control means. The measurements may be performed in the production unit and/or in a separate measurement unit. Also, the measurements may be performed by an operator and input by the operator in a computer terminal which transmits the measurement results to the central control means.

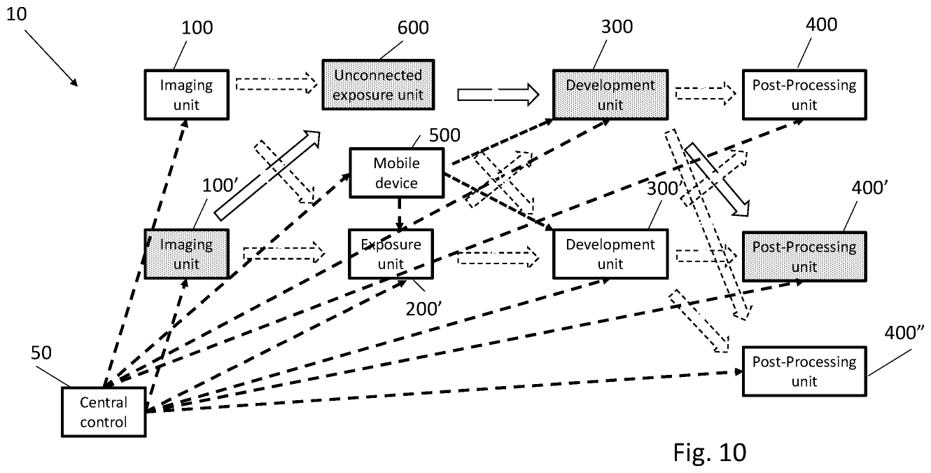

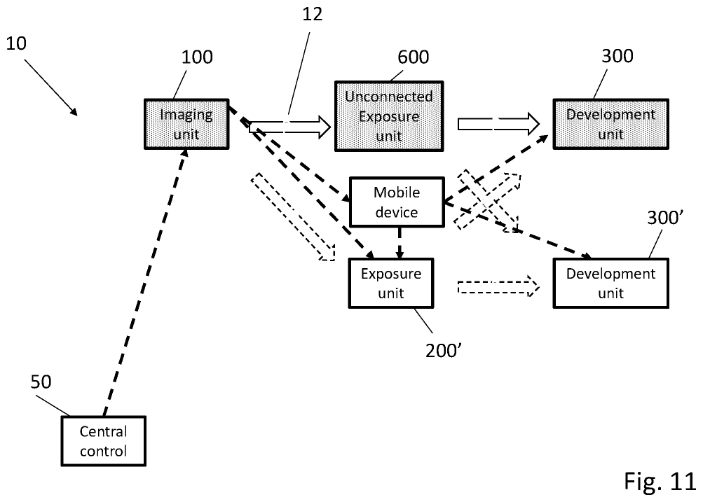

FIGS. 10 and 11 show some embodiments under the third aspect of the present disclosure. The relief plate production system 10 comprises a plurality of production units. The plurality of production units comprises at least one connected production unit 100, 100′, 200′, 300, 300′, 400, 400′, 400″ configured to communicate with a central control means 50 and/or with another connected production unit. The plurality of production units also comprises at least one unconnected production unit 600 unable to communicate with the central control means 50 and/or with the at least one connected production unit. The production system also comprises a mobile device 500 configured to communicate with a central control means 50 and/or with the at least one connected production unit. The mobile device 500 is for example a tablet.

According to some embodiments at least one unconnected production unit 600 does not understand the instruction from the central control means 50. According to some embodiments at least one unconnected production unit 600 is controlled by manual input from an operator.

According to some embodiments, such as that shown in FIG. 10, the relief plate production system 10 comprises a central control means 50.

According to some embodiments, the central control means 50 sends the job instruction to the mobile device 500. According to some embodiments, the central control means 50 sends the job instruction directly to the at least one connected production unit, for example directly to all the connected production units (see for example FIG. 10) or all the connected production units downstream or upstream of the mobile device 500, without the intermediary of the mobile device 500. Alternatively or in addition, as shown in FIG. 11 the central control means 50 only sends the job instruction to one or several production units (the imaging unit 100 in FIG. 11) upstream of the mobile device 500 but not to the production units downstream of and/or at the same production level as the mobile device 500. The imaging unit 100 then sends the job instruction to the mobile device 500 and to one or several connected production units.

According to some embodiments the mobile device 500 sends the job instruction to at least one connected production unit 300, 300′; 400, 400′, 400″ downstream of the unconnected production unit 600, for example to all the connected production units downstream of the unconnected production unit 600.

According to some embodiments, the unconnected production unit 600 performs substantially the same function in plate production as another connected production unit. In the embodiments shown in FIGS. 10 and 11, the unconnected production unit 600 performs substantially the same function in plate production as the exposure unit 200′. Preferably, the mobile device 500 sending a message M1 to any other connected production unit which performs substantially the same function as the unconnected production unit 600, when the unconnected production unit 600 has treated the relief precursor 12 or has started treating the relief precursor 12 or has received the relief precursor 12, to remove the job instruction. Upon receiving the message M1 the connected production unit 200′ removes the job instruction from a list of job instructions.

According to some embodiments the relief plate production system 10 comprises at least two connected production units. Preferably the at least two connected production units are able to communicate with each other, either directly or through a central control means 50. More generally according to some embodiments of the present disclosure there is no direct communication amongst the production units. All the communication amongst the production units is performed through the central control means 50. According to some embodiments some of the at least two connected production units belong to a set of production units, the production units in the same set having substantially the same function. Alternatively or in addition, the at least two connected production units have different functions and are configured to perform different functions in the relief plate production.

Under the third aspect of the disclosure, first the mobile device 500 receives a job instruction. Said job instruction includes at least an identifier of a relief plate 14 to be produced from a relief precursor 12.

Next one unconnected production unit 600 of the at least one unconnected production unit receives a relief precursor 12 and an indication of the identifier of this relief precursor 12. The unconnected production unit 600 then treats the relief precursor 12 in accordance with the received job instruction.

According to some embodiments, an operator enters an input derived from the job instruction received on the mobile device 500 into the unconnected production unit 600. The input is a command comprehensible to the unconnected production unit 600. Alternatively, the mobile device 500 sends the job instruction to the unconnected production unit 600 without the involvement of a human operator. The mobile device 500 sends the job instruction automatically to the unconnected production unit 600, or sends the job instruction to the unconnected production unit 600 upon a request from the unconnected production unit 600, for example when the unconnected production unit 600 informs the mobile device 500 that the former is ready to take instructions.

According to some embodiments, an operator enters an input into the mobile device 500 to indicate that a relief precursor 12 has been or will be treated by the unconnected production unit 500.

According to some embodiments the mobile device 500 sends a message to the central control means 50 and/or to a connected production unit 200′ of the at least one connected production unit 100, 200, 300, 400 to indicate that the relief precursor 12 has been or will be treated by the one unconnected production unit 600. More generally, the status of the unconnected production unit 600 can be made known to the central control means the 50 and/or to at least one connected production unit via the mobile device 500. For example, the mobile device 500 represents the unconnected production unit 600 in the relief plate production system 10. The operator enters data into the unconnected production unit 600. In addition or alternatively, the operator inputs data about the unconnected production unit 600 to the mobile device 500 which sends the data to the central control means 50 and/or a connected production unit.

According to some embodiments of the present disclosure, an operator may enter an input on a machine which has access to the central control means 50, the machine being distinct from the at least one production unit. The input is then sent to the central control means 50. In this way the operator does not have to enter the input on a production unit. This provides the operator with more flexibility.

As shown in the FIGS. 10 and 11, the production system 10 may comprise at least a set of connected production units. The production units of the same set preferably have substantially the same function in the plate production process. In the embodiment shown in FIG. 11 the production system 10 comprises a set of development units 300, 300′. In the embodiment shown in FIG. 10 the production system 10 comprises a set of imaging units 100, 100′, a set of development units 300, 300′, and a set of post-processing units 400, 400′, 400″.

According to some embodiments, at least a part of the job instruction is created externally to the central control means 50, such as by a layout software configured to arrange at least one raster image file, such as a tiff file on an area corresponding to the relief plate precursor. According to some embodiments the rest of the job instruction is completed by the central control means 50, optionally further by a production unit which receives the part of the job instruction.

FIG. 12 shows some embodiments of the content of the job instruction. According to some embodiments the job instruction comprises a name. The name for example includes a time stamp. However, the time stamp may also be included in the job instruction message itself. The time stamp may indicate the moment when the job has been created and is no longer in preparation. As an alternative the time stamp indicates the moment when the job instruction(s) is/are sent from the central control means 50. In some embodiments the time stamp may function as the identifier of the relief precursor, but typically a separate identifier of the relief precursor is added, see below.

In some embodiments, the method further comprises a production unit displaying a set of job instructions received at the respective production unit in an ordered manner, based on the time stamps of the set of job instructions.

In some embodiments, the job instruction may include a priority indication, in which case the priority indication may also be taken into account when displaying the list of job instructions. This may be especially interesting when the production unit is an imaging unit as this is typically a first production unit which largely determines the time schedule.

The job instruction may also include, either in the name or in the message itself, one or more of the following: a producer name, a production location, production date of the precursor, a lot number, an expiry information in terms of print impressions or run length, a colour information on the colour in which the relief plate shall be printing, an ink information on the type or name of ink that shall be used for printing, a printing machine information such as the type or name or technology of printing machine to be used, an orientation information (e.g. indicating printing direction or registration marks), cutting information (cutting marks or instructions), software information (e.g. type and release of software used to generate the image files), the raster image processing conditions, an operator name, quality information, information on the resolution, information on the surface screening applied.

The job instruction may also comprise an identifier of the relief precursor, typically a unique identifier. Each job instruction has its own unique identifier distinct from that of any other job instruction. That unique identifier is according to some embodiments a universally unique identifier (UUID). The UUID may be created using specific software for example Win32 API function UuidCreate that is provided by Microsoft as a part of the Windows API.

Each job preferably has a unique job identifier.

The job instruction may also comprise at least one look-up parameter configured to allow a production unit to determine the configuration settings to be used to treat the relief precursor 12. The look-up parameter may comprise information on the type of the relief precursor 12. Alternatively or in addition, the look-up parameter may comprise information on the size of the relief precursor 12. Alternatively or in addition, the look-up parameter may comprise information on the thickness of the relief precursor 12. Alternatively or in addition, the look-up parameter may comprise information on different treatment options on the same type of relief precursor 12. For example, for one type of the relief precursor 12 it may be desirable that the plate can be treated under different parameters to suit different customer needs. For example, for the plate type A with a customer requirement C1, the job instruction comprises a first series of look-up parameters which enable the production unit to treat the relief precursor 12 with the setting 1. For the plate type A with a customer requirements C2, the job instruction comprises a second series of look-up parameters which enable the production unit to treat the relief precursor 12 with the setting 1′. For a plate type B with a customer requirement C1, the job instruction comprises a third series of look-up parameters which enable a production unit to treat the relief precursor 12 with the setting 2.

According to some embodiments, the job instruction comprises a reference to a preview file or a preview file of the relief plate 14 to be made. The preview file is for instance a low resolution picture of the image file. The preview image is for example legible and/or understandable to a human. The preview image for example comprises at least one object or its lower resolution version in the image file.

According to some embodiments the preview file contains an indication of the identifier of the relief precursor 12, for example a barcode.

According to some embodiments, the job instruction may optionally comprise a reference to an image file, for example a tiff file, used to image the mask layer of the relief precursor 12.

Imaging a relief precursor 12 may require several tiff files. For example, a relief plate 14 may comprise the images from at least two image files. This for example corresponds to the situation where the printed medium has two pictures obtained from two different image files. In this case, the job instruction comprises a reference to at least two image files.

Given the relatively large size of tiff files preferably they are only sent to the imaging units 100, 100′, The preview file is for example sent to all production units, such as the imaging unit, the exposure unit, and/or the development unit, and/or the post-possessing unit.

According to some embodiments, the job instruction may comprise the imaging settings for producing the relief precursor 12. The imaging settings for example comprise the ablation settings for the imaging units 100, 100′, and/or the exposure settings for the exposure units 200, 200′. According to the embodiments where the job instruction comprises a reference to at least the two image files, the job instruction may comprise the imaging settings for each of the image files. For example, the job instruction may comprise a first exposure setting to expose at a lower intensity the first part of the relief precursor 12 which has been imaged with the first image file, and a second exposure setting to expose at a higher intensity the second part of the relief precursor 12 which has been imaged with the second image file.

Optionally, a job instruction can contain the commands for a number of different relief plates 14 to be made.

According to some embodiments the identifier and/or the precursor type are alphanumerical characters inscribed in that relief precursor 12. Alternatively, the identifier and/or the precursor type may be included in barcodes or QR codes inscribed in the relief precursor 12.

In addition, each image file comprises an indication of an identifier, and/or registration marks and/or cutting marks. The identifier, cutting marks or registration marks may be inside the image area or outside of the image area. They may be included to form a relief which can print or a relief which is unable to print. The reliefs may be above or below the plate floor. The identifier may be present in form of a machine-readable code for example a barcode, QR code, microdots, sparse mark code, multibit code or in a code recognisable by a human e.g. an image or alphanumerical characters. The barcode is for example a hash of the UUID. The identifier in the present disclosure can be one or more of those described in WO 2022/026847 Al which is included herein by reference.

According to some embodiments the indication of the identifier and how it is manufactured are those described in WO 2022/112342 A1, or WO 2021/069489 A1, or WO 2020/156692 A1, or WO 2020/043875 A1, which are included herein by reference.

According to some embodiments for the jobs which are created and no longer in preparation at a different moment in time and/or for the job instructions which are sent out at a different moment in time, the job instructions have their own time stamps.

According to some embodiments of the present disclosure an operator reads the indication of the identifier. The operator for example reads the plate type and/or the customer requirements. The operator may also look at the time stamp. The operator may also look at the image of the file, for example the thumbnail of the mask layer, or a picture of the relief plate to be produced. The operator then selects a corresponding job from a list of jobs stored in the production unit which has received the relief precursor 12. For example, he compares the received relief precursor 12 with the pictures of the relief plates on the display and chooses the relief plate that corresponds to the received relief precursor.

According to some embodiments at least one, preferably each of, the plurality of production units has a display. In this case, the operator for instance selects the corresponding job from the list via the display.

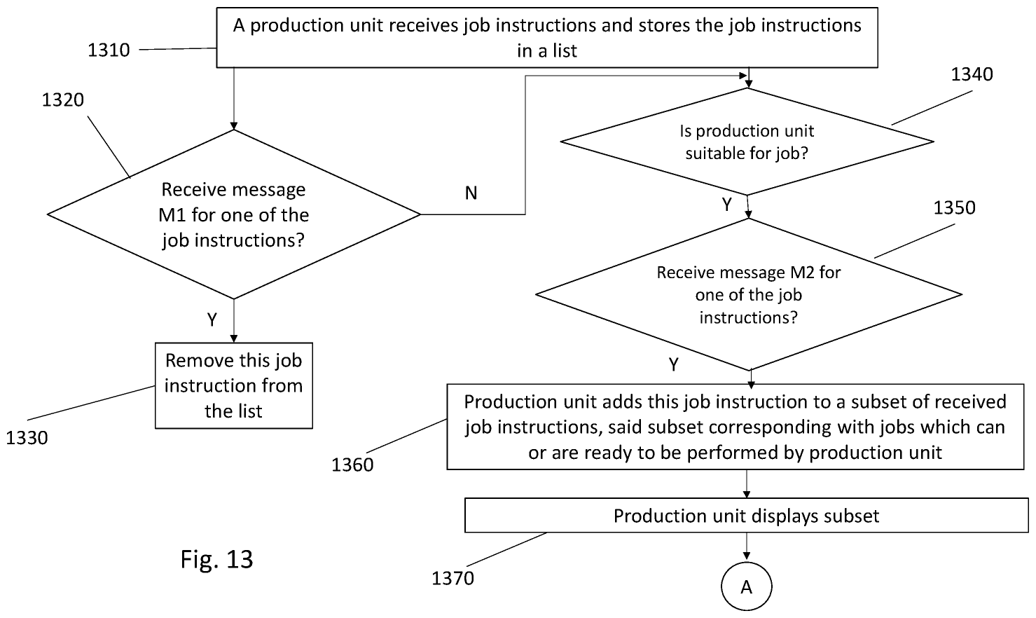

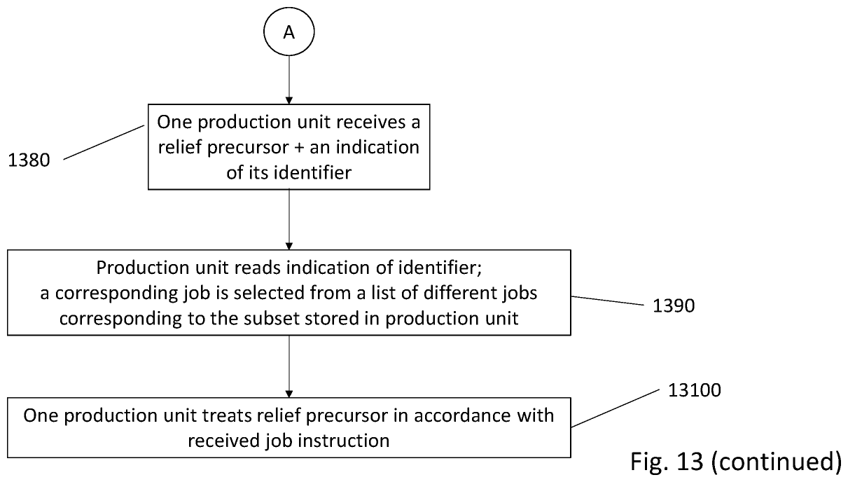

According to some embodiments the method further comprises storing all received job instructions in a list. The method may comprise displaying a subset of the received job instructions, said subset including jobs which are ready to be performed and/or can be performed by the production unit. FIG. 13 is a flow chart showing the steps carried out by a production unit to display only a subset of the received job instructions.

As shown in FIG. 13, in the step 1310 first the production unit receives job instructions. In the step 1310 the production unit also stores the job instructions in a list. Next, in the step 1320 the production unit determines whether it has received the message M1 for one of the job instructions. If the production unit has received the message M1, then in the step 1330 the production unit removes the job instruction from the list of job instructions. If instead the production unit decides that it has not received the message M1 for one of the job instructions, it moves on to the step 1340 to decide whether it is suitable for the job. According to some embodiments, the production unit skips the steps 1320 and 1330 and proceeds from the step 1310 to the step 1340 directly.

If the production unit decides that it is suitable for the job in the step 1340, next it proceeds to the step 1350 to decide whether it has received a message M2 for one of the job instructions. If the production unit decides that it has received the message M2, it adds this job instruction to a subset of received job instructions in the step 1360. The subset corresponds with the jobs that can or are ready to be performed by the production unit. The production unit then displays the subset of the received job instructions, in the step 1370.

When the production unit receives a relief precursor 12 and add indication of its identifier (step 1380) it reads the indication of the identifier. A corresponding job is then selected from a list of jobs corresponding to the subset stored in the production unit, in the step 1390. The production unit then treats the relief precursor 12 in accordance with the received job instruction, in the step 13100.

According to some embodiments said subset includes jobs for which a message M2 has been received from a downstream production unit directly downstream of the respective production unit to indicate that the relief precursor has been or will be processed by the downstream production unit. For example, in reference to FIG. 5 the exposure unit 200 which receives the relief precursor 12 receives a message M2 from one of the development units 300, 300′ directly downstream of the exposure unit 200.

Alternatively or in addition, when the production unit receives a plate, it reads the indication of the identifier. The production unit for example reads an indication corresponding with the time stamp. The production unit then selects a corresponding job from a list of jobs stored in the production unit based thereon. The production unit then derives the plate type and/or the customer identification from the selected job.

Alternatively or in addition, the plurality of production units comprises at least a set of productions unit having substantially the same main function but different optional functions. According to this embodiment a received job instruction may only be displayed on a production unit having suitable optional functions. The optional functions may be a higher exposure intensity, or whether a specific type of development liquid necessary to develop a certain type of exposed relief precursor is available in a development unit.

1. A method of controlling a relief plate production system, the relief plate production system comprising:
a plurality of production units comprising at least one connected production unit configured to communicate with a central control means and/or with another connected production unit, and at least one unconnected production unit unable to communicate with the central control means and/or with the at least one connected production unit, and
a mobile device configured to communicate with the central control means and/or with the at least one connected production unit,
the method comprising the steps of:
the mobile device receiving a job instruction, said job instruction including at least an identifier of a relief plate to be produced from a relief precursor;
one unconnected production unit of the at least one unconnected production unit receiving a the relief precursor and an indication of the identifier of this relief precursor, and treating the relief precursor in accordance with the received job instruction,
sending by the mobile device a message to the central control means and/or to a connected production unit of the at least one connected production unit, said message indicating that the relief precursor has been or will be treated by the one unconnected production unit.

2. The method of claim 1, wherein the relief plate production system comprises at least two connected production units, the at least two connected production units being able to communicate with each other, either directly or through a central control means.

3. The method of claim 1, further comprising entering by an operator an input derived from the job instruction received on the mobile device, into the unconnected production unit; and/or
further comprising entering by an operator an input into the mobile device to indicate that a relief precursor has been or will be treated by the unconnected production unit.

4. (canceled)

5. The method according to claim 1, wherein the relief plate production system comprises a central control means, the central control means sending the job instruction to the mobile device and sending the job instruction directly to the at least one connected production unit without the intermediary of the mobile device; and/or
further comprising sending by the mobile device the job instruction to at least one connected production unit of the at least one connected production unit downstream of the unconnected production unit.

6. (canceled)

7. A method of controlling a relief plate production system comprising a plurality of production units using a central control means configured for controlling the relief plate production system, the method comprising the steps of:
each of the plurality of production units receiving a job instruction from the central control means and storing said job instruction in a list of job instructions, said job instruction including at least an identifier of a relief plate to be produced from a relief precursor;
after the plurality of production units have received the job instruction, one production unit of the plurality of production units receiving a relief precursor and an indication of the identifier of this relief precursor and treating the relief precursor in accordance with the received job instruction.

8. The method of claim 7, further comprising after or before the one production unit has treated the relief precursor, another production unit of the plurality of production units receiving a relief precursor and an indication of the identifier of this relief precursor and treating the relief precursor in accordance with the received job instruction.

9. The method of claim 7, further comprising broadcasting by the central control means of the job instruction to the plurality of production units.

10. The method of claim 7, further comprising sending by the central control means the job instruction upon a request of a production unit of the plurality of production units and/or when a production unit of the plurality of production units is switched on or re-activated; and/or
wherein each job has a unique job identifier, the method further comprising at least one production unit requesting from the central control means a list of the job identifiers of all the available jobs, comparing a list of the job identifiers of the production unit making the request and the list of the job identifiers of all the available jobs received from the central control means, and requesting the job instruction of at least one job whose job identifier is on the list of the job identifiers of all the available jobs but missing from the list of the job identifiers of the production unit making the request.

11. (canceled)

12. The method of claim 7, wherein the plurality of production units comprises a set of production units, and the one production unit is one of the set of production units, wherein preferably the production units in the set perform substantially the same function in plate production; the method further comprising:
removing the job instruction from the list of job instructions stored on any other production unit of the set of production units which have not received the relief precursor;
wherein preferably the method comprises sending a message by the one production unit to any other production unit of the set, either directly or through the central control means, indicating that the one production unit has treated the relief precursor or has started treating the relief precursor or has received the relief precursor; and/or
the method further comprises after or before the one production unit has treated the relief precursor, another production unit of the plurality of production units receiving a relief precursor and an indication of the identifier of this relief precursor and treating the relief precursor in accordance with the received job instruction, and further comprises sending by the one production unit a message to the other production unit, either directly or through the central control means, indicating that the relief precursor treated by the one production unit is ready to be treated by the other production unit, and optionally displaying the job instruction for the relief precursor on a display of the other production unit.

13. (canceled)

14. (canceled)

15. A method of controlling a relief plate production system comprising a plurality of production units including at least a first production unit and a set of second production units directly downstream of the first production unit, wherein preferably the second production units in the set perform substantially the same function in plate production; the method comprising the steps of:
receiving at the first production unit a job instruction and storing said job instruction in a list of job instructions, said job instruction including at least an identifier of a relief plate to be produced from a relief precursor;
receiving a relief precursor and an indication of the identifier at the first production unit and treating said relief precursor in accordance with the received instruction;
removing the job instruction from the first production unit;
sending by the first production unit a second job instruction to the set of second production units, said second job instruction including at least the identifier;
receiving the treated relief precursor at one of the set of second production units and further treating said relief precursor in accordance with the received second job instruction;
removing the second job instruction from all second production units of the set.

16. The method of claim 15, wherein the sending comprises sending by the first production unit the job instruction to all production units downstream of the first production unit, or only to the set of second production units directly downstream of the first production unit.

17. The method of claim 15, further comprising sending a message by the one second production unit to any other second production unit of the set, when the one second production unit has treated the relief precursor or has started treating the relief precursor or has received the relief precursor, to remove the second job instruction, whereupon the other second production unit removes the second job instruction from a list of job instructions.

18. The method of claim 15, further comprising, after receiving the relief precursor at the one second production unit, reading the indication of the identifier by the one second production unit, and retrieving the second job instruction from a memory of the one second production unit based on the read indication.

19. The method of claim 15, wherein the first production unit is part of a set of first production units, wherein preferably the first production units in the set perform substantially the same function in plate production; the method comprising:
receiving the job instruction at all first production units of the set;
sending a message by the first production unit to any other first production unit of the set, when the first production unit has treated the relief precursor or has started treating the relief precursor or has received the relief precursor, to remove the job instruction, whereupon the other first production unit removes the job instruction from a list of job instructions; and/or
wherein the first production unit is an exposure unit, and wherein the set of second production units is a set of development units; and/or
wherein the job instruction is received at the first production unit from an imaging unit or from a central control means, wherein preferably the imaging unit is part of a set of imaging units, the method comprising receiving at the set of imaging units the job instruction from the central control means.

20-22. (canceled)

23. The method of claim 1, wherein the job instruction includes one or more look-up parameters for looking up one or more configuration parameters stored at the production unit, wherein preferably the one or more look-up parameters include at least one of the following: a type of precursor, a thickness of the precursor, information on a size of the precursor, a client identifier; and/or
wherein the job instruction includes a reference to a preview image or a preview image, preferably further comprising, preferably prior to the receiving of a job instruction at a respective production unit, receiving the preview image at the respective production unit and displaying the preview image together with the job instruction at the respective production unit; and/or
wherein the job instruction includes a reference to one or more image files to be used by a production unit, such as an imaging unit, and/or an imaging setting to be used by the imaging unit, wherein preferably the plurality of production units comprises an imaging unit, the method further comprising, preferably prior to the receiving of a job instruction at the imaging unit, receiving the one or more image files at the imaging unit; and/or
the job instruction includes, e.g. in its file name, a time stamp, e.g. including a date and a time, and optionally a name chosen by a creator of the file, preferably further comprising the production unit displaying a set of job instructions received at the respective production unit in an ordered manner, based on the time stamp of the set of job instructions.

24-30. (canceled)

31. The method of claim 1, wherein the plurality of production units comprises an imaging unit, and wherein the indication of the identifier is generated in the relief precursor by the imaging unit; and/or
wherein the plurality of production units comprises at least a first set of productions unit upstream of a second set of productions units, wherein production units of the same set preferably have substantially the same function; and/or
wherein the plurality of production units comprises any one of the following: a transport unit, a pre-processing unit, an imaging unit, an exposure unit, a development unit, such as a washer or a thermal development unit, a post-processing unit, such as a dryer, a post-exposure unit, such as a cutting unit configured to cut the plate, a mounting unit configured to mount the relief precursor onto a substrate such as a sleeve, a storage unit.

32. (canceled)

33. (canceled)

34. The method of claim 1, further comprising an operator reading the indication of the identifier and selecting a corresponding job from the list of jobs stored in a production unit of the plurality of production units, which has received the relief precursor; and/or
further comprising the production unit reading the indication of the identifier and selecting a corresponding job from the list of jobs stored in a production unit of the plurality of production units, which has received the relief precursor; and/or
wherein the identifier is attached or integrated to the relief precursor or to a carrier, such as a trolley, carrying the relief precursor.

35. (canceled)

36. (canceled)

37. The method of claim 1, wherein a production unit of the plurality of production units has a display, the method further comprising displaying a subset of the job instructions received at said production unit, said subset corresponding with jobs which have been treated or are being treated by a production unit directly downstream of said production unit and which can be performed by said production unit, wherein preferably said subset includes jobs for which a message has been received from a downstream production unit directly downstream of the respective production unit to indicate that the relief precursor has been or will be processed by the downstream production unit; and/or
wherein the plurality of production units comprises at least a set of productions unit having substantially the same main function but different optional functions, and wherein a received job instruction is only displayed on a production unit having suitable optional functions; and/or
the method further comprising the step of performing measurements on a plate treated in a production unit of said plurality of production units and transmitting a result of the measurements by said production unit, a measurement unit, and/or by a computer terminal, preferably a mobile terminal, to the central control means.

38-40. (canceled)

41. A central control means configured for controlling a relief plate production system, preferably for use in a method of any one of the previous claims, comprising a plurality of production units, the central control means being configured for transmitting to each of the plurality of production units a job instruction, said job instruction including at least an identifier of a relief plate to be produced from a relief precursor; wherein preferably the transmitting comprises broadcasting the job instruction; and/or
wherein the transmitting comprises transmitting the job instruction upon receiving a request of a production unit of the plurality of production units and/or when detecting that a production unit of the plurality of production units is switched on or re-activated; and/or
the central control means is further configured to receive a message when a respective production unit of the plurality of production units will start or has started or has finished a job corresponding with a job instruction, and, in response, at least one of:
to inform at least one other production unit which no longer has to perform the job, to remove the job instruction;
to inform at least one other production unit downstream of the respective production unit that the respective production unit will start or has started or has finished the job corresponding with the job instruction; and/or
wherein the job instruction includes one or more look-up parameters for looking up one or more configuration parameters stored at the production unit, wherein preferably the one or more look-up parameters include at least one of the following: a type of the precursor, a thickness of the precursor, information on a size of the precursor, a client identifier; and/or
wherein the job instruction includes a reference to a preview image, and wherein the central control means is configured to transmit, preferably prior to the transmitting of the job instruction, the preview image; and/or
wherein the job instruction includes a reference to one or more image files to be used by a production unit, such as an imaging unit, and/or an imaging setting to be used by the imaging unit, and wherein the central control means is configured to transmit to the imaging unit, preferably prior to the transmitting of the job instruction, the one or more image files; and/or
wherein the central control means is configured to generate the job instruction so that it includes, e.g. in its file name, a time stamp, e.g. including a date and a time, and optionally a name chosen by a creator of the file; and/or
wherein the central control means is configured to keep track of jobs corresponding with job instructions transmitted to the plurality of productions units and maintains a database storing for each job instruction which one or more production units have performed the job and/or are scheduled to perform the job, optionally together with time data related to when the job has been performed or when it is scheduled to be performed.

42-49. (canceled)

50. A production unit of a relief plate production system, preferably for use in a method of claim 1, said production unit configured to receive a job instruction including at least an identifier of a relief plate to be produced from a relief precursor, to store the job instruction in a list of job instructions, to receive a relief precursor and an indication of the identifier of this relief precursor, and to treat the relief precursor in accordance with the received job instruction; wherein preferably the production system is further configured to send a request to a central control means to receive job instructions potentially intended for the production unit, and, in response, to receive said job instructions from the central control means and to store them and/or wherein the production unit is configured to signal to the central control means that it is switched on or re-activated, and, in response to receive said job instructions and store them; and/or
the production system is further configured to transmit, when the production unit will start or has started or has finished a job corresponding with a job instruction, at least one of:
a message to inform at least one other production unit which no longer has to perform the job, to remove the job instruction;
a message to inform at least one other production unit downstream of the production unit that the production unit will start or has started or has finished the job corresponding with the job instruction; and/or
wherein the job instruction includes one or more look-up parameters for looking up one or more configuration parameters stored at the production unit, wherein preferably the one or more look-up parameters include at least one of: a type of the plate, a thickness of the plate, information on a size of the plate, a client identifier, and wherein the production unit is configured to set one or more configuration parameters based on the one or more look-up parameters; and/or
wherein the job instruction includes a reference to a preview image or a preview image, and wherein the production unit is configured to receive, preferably prior to the receiving of the job instruction, the preview image, and to display the preview image together with the job instruction; and/or
wherein the production unit is an imaging unit, and wherein the job instruction includes a reference to one or more image files to be used by the imaging unit, and/or an imaging setting to be used by the imaging unit, and wherein the imaging unit is configured to receive, preferably prior to the receiving of the job instruction, the one or more image files, wherein preferably the imaging unit is configured to generate, preferably image, the indication of the identifier in the relief precursor based on the received job instruction; and/or
wherein the job instruction includes, e.g. in its file name, a time stamp, e.g. including a date and a time, and optionally a name chosen by a creator of the file, and wherein the production unit is configured to display a list of the received job instructions in an orderly manner based on the time stamps thereof; and/or
the production system is further configured to transmit the received job instruction to one or more other production units downstream of the production unit; and/or
wherein the production unit is or comprises any one of the following: a transport unit, a pre-processing unit, an imaging unit, an exposure unit, a development unit, such as a washer or a thermal development unit, a post-processing unit, such as a dryer, a post-exposure unit, such as a cutting unit configured to cut the plate, a mounting unit configured to mount the relief precursor onto a substrate such as a sleeve, a storage unit; and/or
the production system is further configured to read the indication of the identifier of a received relief precursor and select a corresponding job from the list of jobs stored in the production unit; and/or
the production system further comprising a display and further configured to display a subset of the job instructions received at the production unit, said subset corresponding with jobs which have been treated or are being treated by another production unit directly downstream of said production unit and which can be performed by the production unit wherein preferably said subset includes jobs for which a message has been received from another production unit directly downstream of the production unit to indicate that the relief precursor has been or will be processed by the downstream production unit.

51-63. (canceled)
